(19) United States
(12) Patent Application Publication
(10) Pub. No.: US 2012/0191579 A1
(43) Pub. Date: Jul. 26, 2012

(54) Selective Processing of Reverse Invoices in Computer Systems for Financial Transactions

(75) Inventors: Mimi O. Ahn, North Reading, MA (US); Steven J. Hauptman, Sudbury, MA (US); Kavita Patil, Westford, MA (US)

(73) Assignee: INTERNATIONAL BUSINESS MACHINES CORPORATION, Armonk, NY (US)

(21) Appl. No.: 13/009,933

(22) Filed: Jan. 20, 2011

(51) Int. Cl. G06Q 40/00

(52) U.S. Cl. 705/30

(57) ABSTRACT

According to one embodiment of the present invention, a system manages financial records, and comprises a computer system including at least one processor. The system generates an electronic invoice representing a financial transaction to rectify financial records adjusted in accordance with a prior processed invoice. The generated electronic invoice is selectively stored for subsequent verification without adjustment of the financial records. The stored electronic invoice is processed to rectify the financial records in accordance with the represented financial transaction in response to verification of the stored electronic invoice. Embodiments of the present invention further include a method and computer program product for managing financial records within a computerized financial system in substantially the same manner described above.

### BACKGROUND

1. Technical Field

The present invention relates to computer or processing systems for financial transactions, and more specifically, to selective processing of reverse invoices within the financial computer or processing systems.

2. Discussion of the Related Art

Financial (FI) accounting systems automatically post account entries to a General Ledger in response to the entries being saved in the financial accounting systems. Occasionally, an invoice produced by a financial accounting system may need to be reversed or removed from financial records within the General Ledger (e.g., in case of an error without performing the return of the goods, etc.). In order to accomplish reversal of the invoice, a user may generate a reverse invoice for processing by the financial accounting system. The reverse invoice includes a transaction that effectively modifies or nullifies the transaction of the produced invoice within the financial records of the General Ledger. The reverse invoice is similarly posted automatically to the General Ledger in response to the reverse invoice being entered and saved in the financial accounting system. When the reverse invoice contains an error or is erroneously directed to the wrong invoice, several accounting entries typically need to be generated in order to correct this error within the financial records of the General Ledger.

### BRIEF SUMMARY

According to one embodiment of the present invention, a system manages financial records, and comprises a computer system including at least one processor. The system generates an electronic invoice representing a financial transaction to rectify financial records adjusted in accordance with a prior processed invoice. The generated electronic invoice is selectively stored for subsequent verification without adjustment of the financial records. The stored electronic invoice is processed to rectify the financial records in accordance with the represented financial transaction in response to verification of the stored electronic invoice. Embodiments of the present invention further include a method and computer program product for managing financial records within a computerized financial system in substantially the same manner described above.

### BRIEF DESCRIPTION OF THE SEVERAL VIEWS OF THE DRAWINGS

FIG. 1. is a diagrammatic illustration of an example computing environment for use with an embodiment of the present invention.

FIG. 2 is a block diagram of modules within a financial system for processing a reverse invoice according to an embodiment of the present invention.

FIG. 3 is a flow diagram for a reverse invoice module of the financial system for processing a reverse invoice according to an embodiment of the present invention.

FIG. 4 is a flow diagram for a change status module of the financial system for enabling approval or cancellation of a reverse invoice according to an embodiment of the present invention.

FIG. 5 is a flow diagram illustrating the manner in which a reverse invoice is processed within the financial system according to an embodiment of the present invention.

FIGS. 6A-6C are flow diagrams illustrating the manner in which example reverse invoices are automatically processed according to an embodiment of the present invention.

FIGS. 7A-7C are flow diagrams illustrating the manner in which example reverse invoices are selectively processed according to an embodiment of the present invention.

FIGS. 8A-8B are schematic illustrations of example graphical user interface screens for generating and selecting a reverse invoice for processing according to an embodiment of the present invention.

FIGS. 9A-9B are schematic illustrations of example graphical user interface screens for selectively approving or cancelling an example reverse invoice according to an embodiment of the present invention.

### DETAILED DESCRIPTION

Present invention embodiments pertain to processing of reverse invoices within financial computer or processing systems. A reverse invoice generally includes a transaction that effectively modifies or nullifies a transaction of a prior invoice, and may be used for various situations (e.g., to correct an error within the prior invoice without performing the return of the goods, etc.). A plural stage process enables creation of a reverse invoice, and provides a user with an intermediate stage to enable cancellation of the reverse invoice prior to posting of account entries corresponding to the reverse invoice within the financial computer system. If a correct invoice is selected to be reversed, a corresponding reverse invoice is approved and processed, and transactions corresponding to the reverse invoice are posted by the financial computer system to the General Ledger.

However, in the case where a wrong invoice is selected for reversal, the intermediate stage of present invention embodiments avoids the need to generate and process additional accounting entries to correct the effects of the erroneous reverse invoice within the financial records of the General Ledger. Basically, when a user enters a reverse invoice, the user has the option to select a status for the reverse invoice (e.g., a “Pending Reverse” status) that enables the user to later selectively approve or cancel the entered reverse invoice. Thus, the reverse invoice may be canceled prior to posting to the General Ledger. This reduces the complexity of maintaining accounting journals, and obviates the need for the user to create a new invoice when a wrong invoice has been reversed.

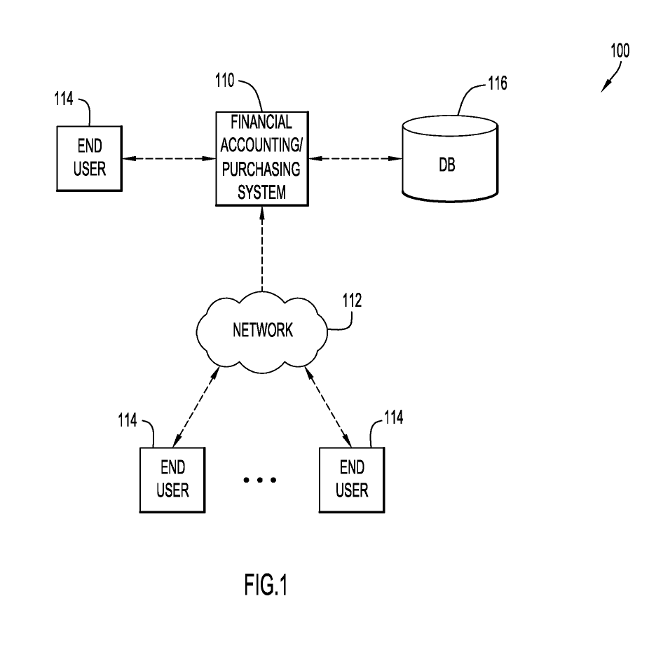

An example environment for use with present invention embodiments is illustrated in FIG. 1. Specifically, environment 100 includes one or more financial accounting and/or purchasing server systems 110, and one or more client or end-user systems 114. Financial systems 110 and client systems 114 may be remote from each other and communicate over a network 112. The network may be implemented by any number of any suitable communications media (e.g., wide area network (WAN), local area network (LAN), Internet, Intranet, etc.). Alternatively, financial systems 110 and client systems 114 may be local to each other, and communicate via any appropriate local communication medium (e.g., local area network (LAN), hardwire, wireless link, Intranet, etc.).

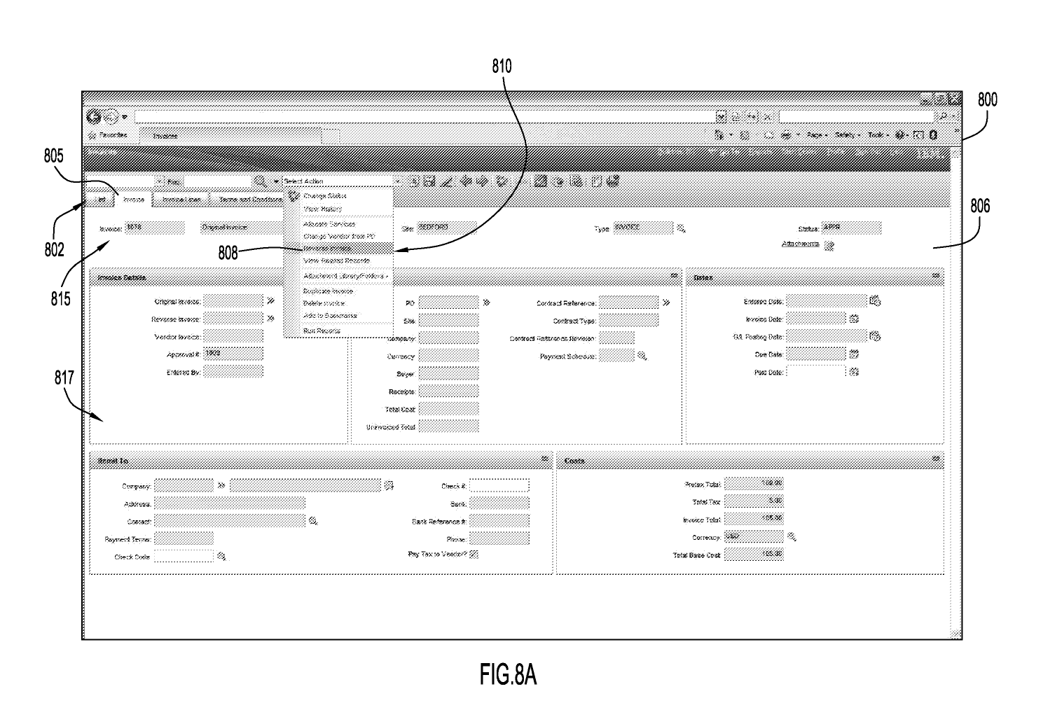

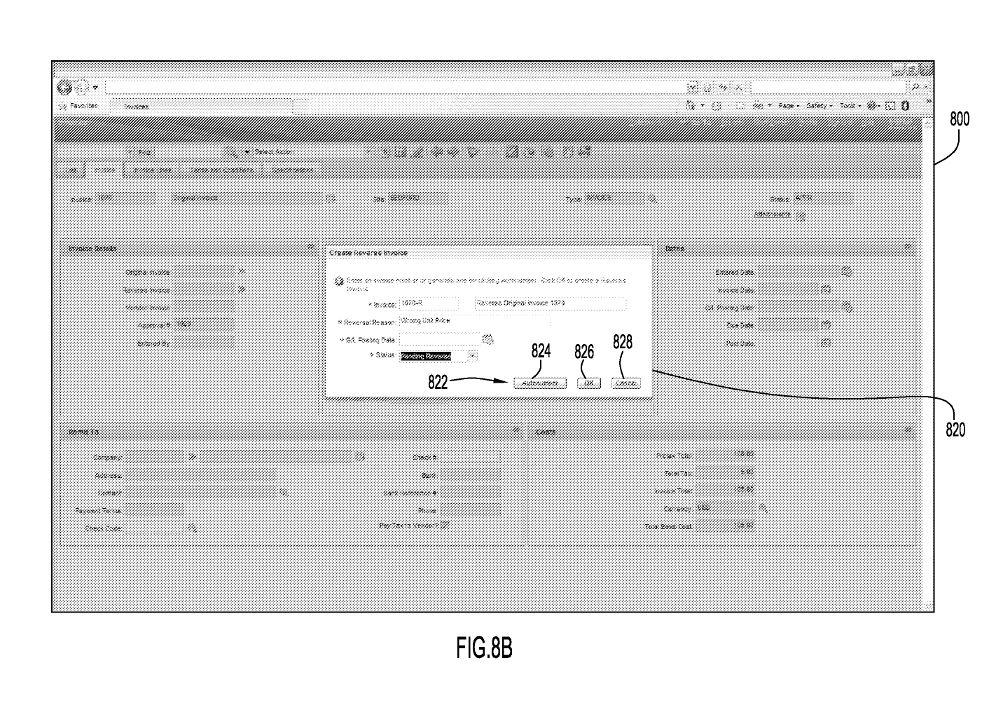

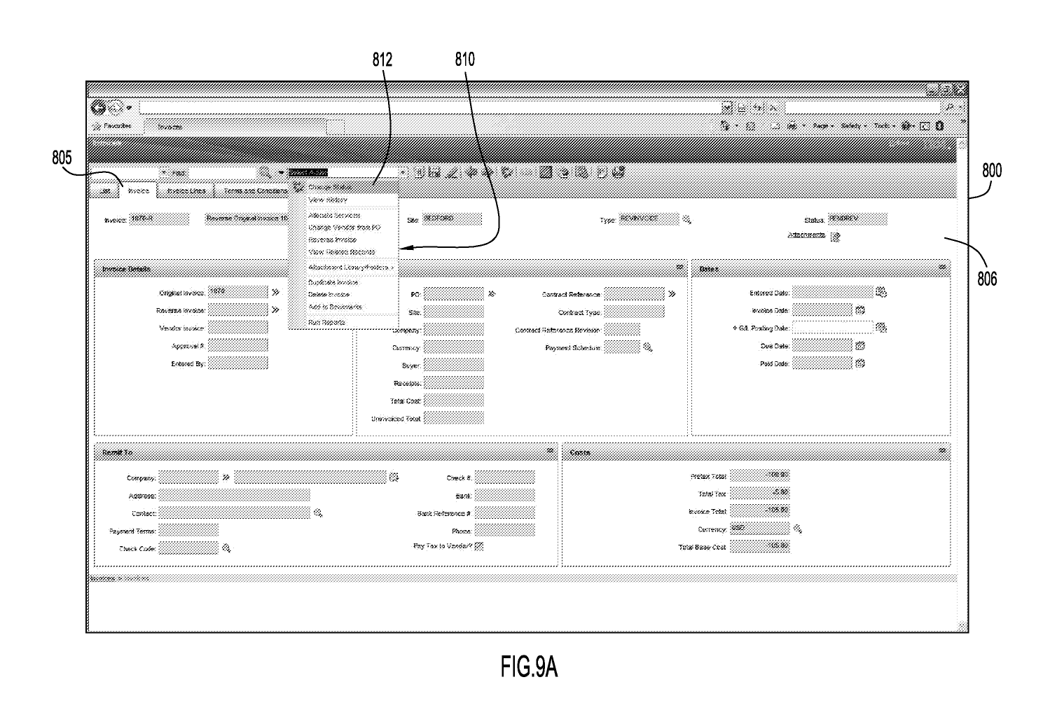

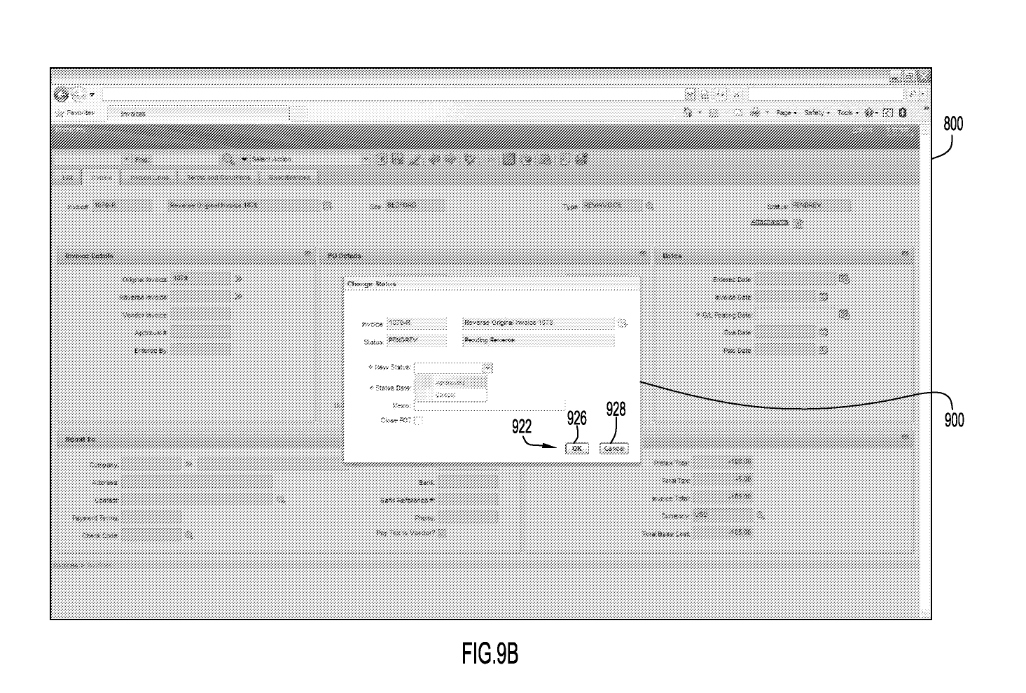

Client systems 114 enable users to interact with financial systems 110 to perform various financial operations (e.g., create, post, and/or edit financial entries, etc.). The financial information (e.g., entries, financial records, General Ledgers, etc.) is stored within one or more database systems 116. The database systems may be implemented by any conventional or other databases or storage units, may be local to or remote from financial systems 110 and client systems 114, and may communicate via any appropriate communication medium (e.g., local area network (LAN), wide area network (WAN), Internet, hardwire, wireless link, Intranet, etc.). Financial systems 110 include invoice and other modules to process invoices as described below. Client systems 114 may present a graphical user (e.g., GUI, etc.) or other interface (e.g., command line prompts, menu screens, etc.) to solicit information from users pertaining to the desired entries and financial operations, and provide various financial reports (e.g., See FIGS. 8A-8B and 9A-9B).

Financial systems 110 and client systems 114 may be implemented by any conventional or other computer systems preferably equipped with a display or monitor, a base (e.g., including the processor, memories and/or internal or external communications devices (e.g., modem, network cards, etc.)), optional input devices (e.g., a keyboard, mouse or other input device), and any commercially available and/or custom software (e.g., server/communications software, invoice and other modules, browser/interface software, etc.).

Alternatively, one or more client systems 114 may perform invoice processing and other financial operations when operating as a stand-alone unit. In a stand-alone mode of operation, the client system stores or has access to financial data, and includes the invoice and other modules to perform the financial operations. The graphical user (e.g., GUI, etc.) or other interface (e.g., command line prompts, menu screens, etc.) solicits information from a corresponding user pertaining to the desired entries and financial operations, and may provide various financial reports.

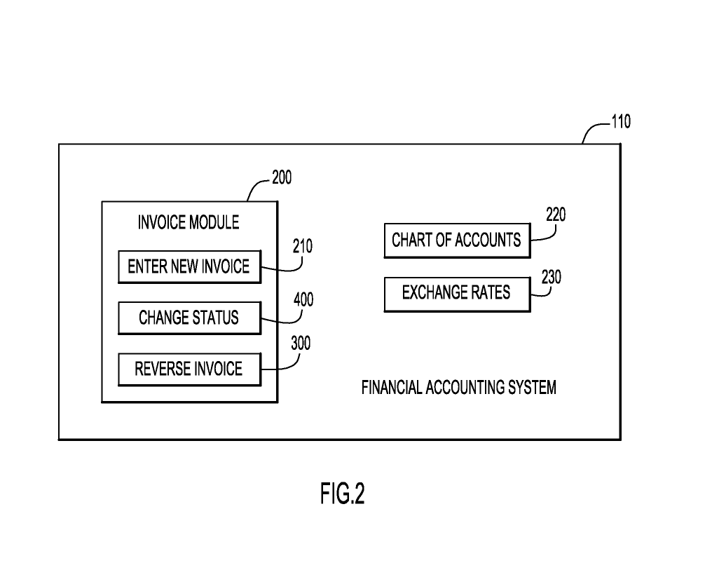

Financial accounting system 110 includes various modules to process entries and perform financial transactions as illustrated in FIG. 2. Specifically, financial system 110 includes invoice module 200 to process invoices, a chart of accounts module 220, and an exchange rates module 230. Chart of accounts module 220 provides information for accounts within the General Ledger, while exchange rates module 230 provides exchange rates for various currencies. These modules basically assist with posting of entries within the General Ledger. The various modules (e.g., chart of accounts module, exchange rates module, invoice module, etc.) of the financial and client systems may be implemented by any combination of any quantity of software and/or hardware modules or units.

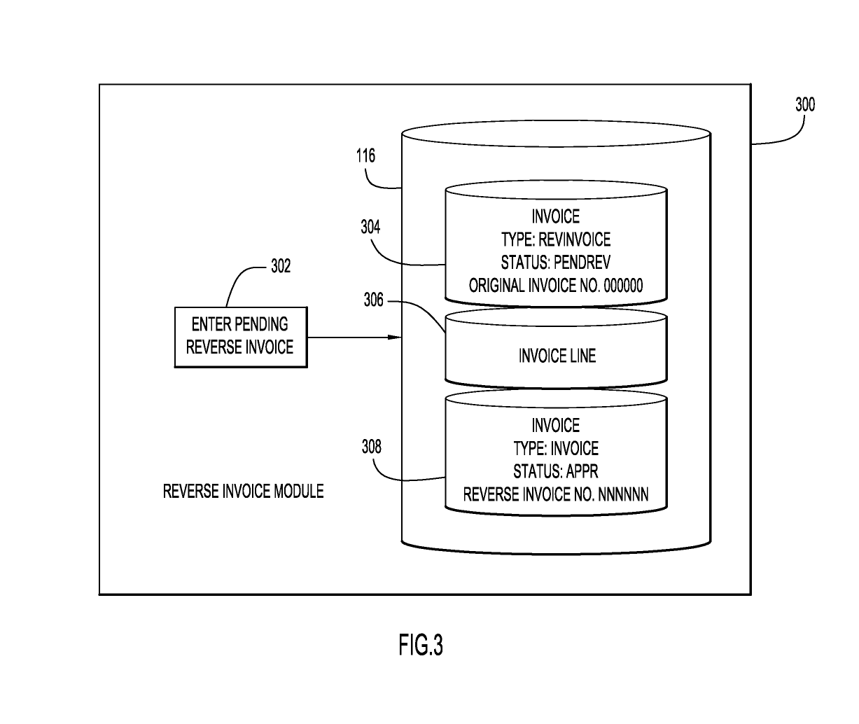

Invoice module 200 includes a new invoice module 210, a reverse invoice module 300, and a change status module 400. New invoice module 210 enables entry of a new invoice within the financial system. The invoice may be entered, generated, and/or produced in any desired form or fashion (e.g., electronically, hard copy form, etc.). Reverse invoice module 300 provides generation and processing of reverse invoices within the financial system as illustrated in FIG. 3. Specifically, a pending reverse invoice is entered into financial system 110 by a user via reverse invoice module 300 at step 302. The reverse invoice may be entered, generated, and/or produced in any desired form or fashion (e.g., electronically, hard copy form, etc.). The financial system (e.g., via reverse invoice module 300) subsequently generates a reverse invoice 304 and an invoice line document 306 (e.g., containing information concerning the invoice and/or transaction), and stores these items in database system 116. Reverse invoice 304 includes information including an appropriate status (e.g., “Pending Reverse” as viewed in FIG. 3) and the original invoice number (e.g., “OOOOOO” as viewed in FIG. 3). The invoice number of an original invoice 308 is updated by financial system 110 (e.g., via reverse invoice module 300) to store a new reverse invoice number (e.g., “NNNNNN” as viewed in FIG. 3). This prevents original invoice 308 from being reversed while there is a corresponding pending reverse invoice.

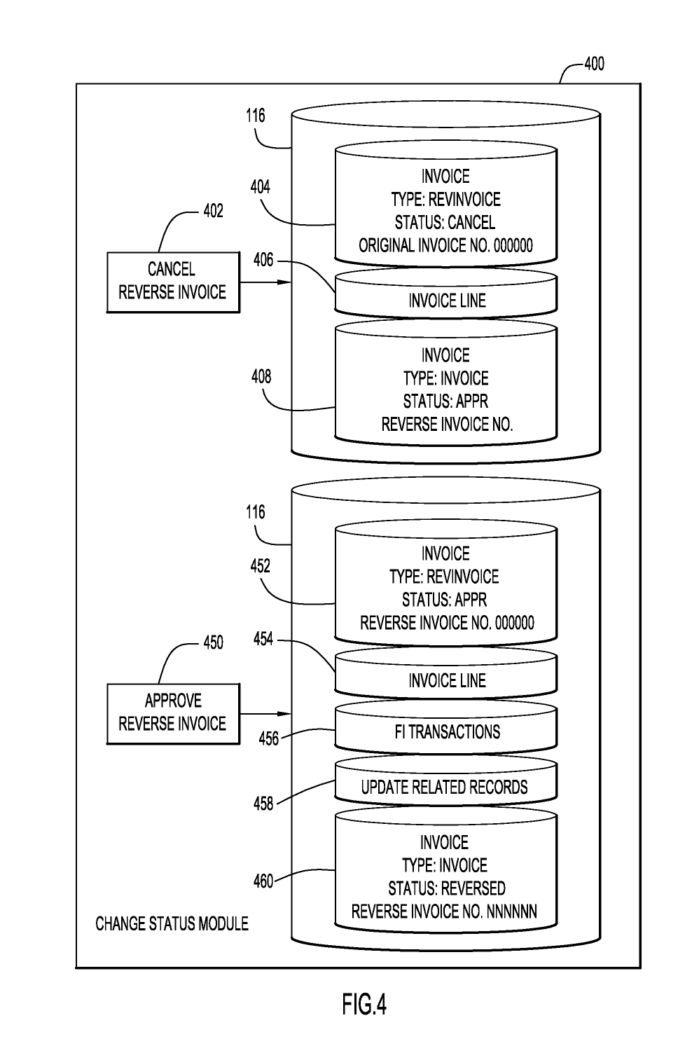

Change status module 400 enables a user to selectively approve or cancel a reverse invoice prior to posting of that reverse invoice to the General Ledger as illustrated in FIG. 4. Initially, a user may discover that a wrong invoice was reversed. In this case, the reverse invoice corresponding to this reversal needs to be canceled in order to restore the reversed invoice within the financial system. Financial system 110 (e.g., via change status module 400) enables the user to cancel the corresponding reverse invoice at step 402. When a reverse invoice 404 is canceled, financial system 110 (e.g., via change status module 400) changes the status of reverse invoice 404 (e.g., to canceled as viewed in FIG. 4) and corresponding information within invoice line document 406. The financial system further updates the invoice number of an original invoice 408 to remove the reverse invoice number and effectively cancel the reverse invoice. Information for updated invoice 408 is stored within database system 116.

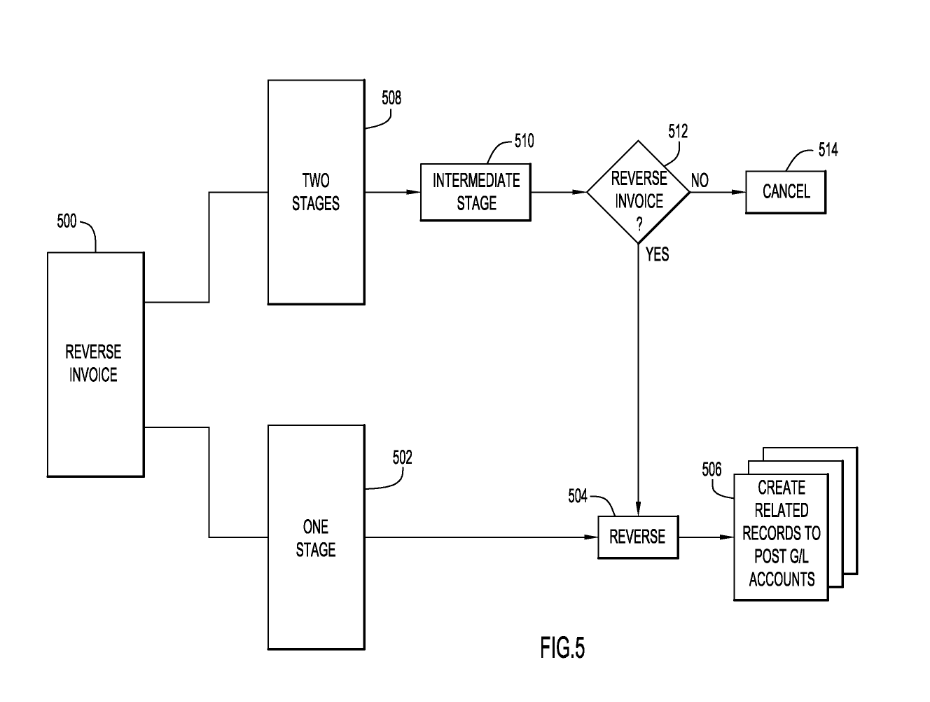

In the case where a reverse invoice 452 is approved at step 450, financial system 110 (e.g., via change status module 400) updates the status of reverse invoice 452 to indicate the approval (e.g., the status is changed to approved as viewed in FIG. 4), and further updates corresponding information within invoice line document 454. Financial system 110 (e.g., via change status module 400) processes the reverse invoice to reverse all of the original financial accounting transactions 456 and entries 458 associated with a corresponding original invoice 460, and updates the status of that original invoice to indicate the reversal (e.g., the status is changed to reversed as viewed in FIG. 4). 100231 The manner in which a reverse invoice is processed by financial system 110 according to an embodiment of the present invention is illustrated in FIG. 5. Initially, a reverse invoice may be created by a user via financial system 110 to modify or nullify a prior invoice within the financial records of the General Ledger. Specifically, the reverse invoice processing by financial system 110 commences at step 500. The financial system may process the reverse invoice in a single stage or within plural stages as described below. The reverse invoice may be entered, generated, and/or produced in any desired form or fashion (e.g., electronically, hard copy form, etc.).

The single stage processing commences at step 502, and a reverse invoice may be created to modify or nullify a prior invoice. This may be accomplished by financial system 110 (e.g., via invoice module 200) employing a graphical user interface (GUI) as illustrated in FIG. 8A. By way of example, user interface screen 800 includes a series of tabs 802 each for navigating to a desired user interface area. An invoice tab 805 enables an invoice area 806 to be displayed that provides various fields pertaining to an invoice. For example, invoice area 806 includes primary fields 815 pertaining to the invoice number, site location, type, and status, and a plurality of sections 817 each including invoice information. By way of example, sections 817 include sections pertaining Invoice Details (e.g., as viewed in FIG. 8A and including fields for the original invoice number, reverse invoice number, vendor invoice number, approval number, and user entering the invoice), PO (or purchase order) Details (e.g., as viewed in FIG. 8A and including fields for the purchase order, site, company, buyer, receipts, total cost, uninvoiced total, contract reference, contract type, contract reference revision, and payment schedule), Dates (e.g., as viewed in FIG. 8A and including fields for the entered date, invoice date, G/L (or General Ledger) posting date, due date, and paid date), Remit to (e.g., as viewed in FIG. 8A and including fields for the company name, address, contact, payment terms, check code, check number, bank, bank reference number, and phone number, and a pay tax to vendor checkbox), and Costs (e.g., as viewed in FIG. 8A and including fields for the pretax total, total tax, invoice total, currency, and total base cost).

The user may enter information within one or more of primary fields 815 (e.g., invoice number, site location, type, and status) to enable financial system 110 (e.g., via invoice module 200) to retrieve information from database system 116 pertaining to a desired original invoice. The retrieved information is placed in the corresponding fields of invoice area 806 for display. A reverse invoice action 808 is selected by the user from a drop-down menu 810, and an invoice dialog box 820 is displayed by financial system 110 (e.g., via reverse invoice module 300) as illustrated, by way of example, in FIG. 8B. The invoice dialog box may include fields pertaining to the invoice number, reason for the reversal, General Ledger posting date, and the invoice status. Invoice dialog box 820 further includes actuators or buttons 822. These buttons may include a number generation button 824 (e.g., “Autonumber” as viewed in FIG. 8B) to enable automatic generation of an invoice number, a proceed button 826 (e.g., “OK” as viewed in FIG. 8A) to proceed with performance of a task, and a cancel button 828 (e.g., “Cancel” as viewed in FIG. 8B) to cancel performance of the task. Information pertaining to the desired reverse invoice is entered within the invoice dialog box fields (e.g., the invoice number, reason for the reversal, General Ledger posting date and the invoice status). Number generation button 824 may be utilized to enable financial system 110 to generate the invoice number. The status for the reverse invoice may be selected to be either pending (e.g., “Pending Reverse” as viewed in FIG. 8B) or approved.

Once the reverse invoice is created with a status of approved, the reverse invoice is immediately processed by financial system 110 (e.g., via change status module 400) to automatically reverse the corresponding original invoice at step 504 (FIG. 5). The reverse invoice is further posted to the General Ledger at step 506.

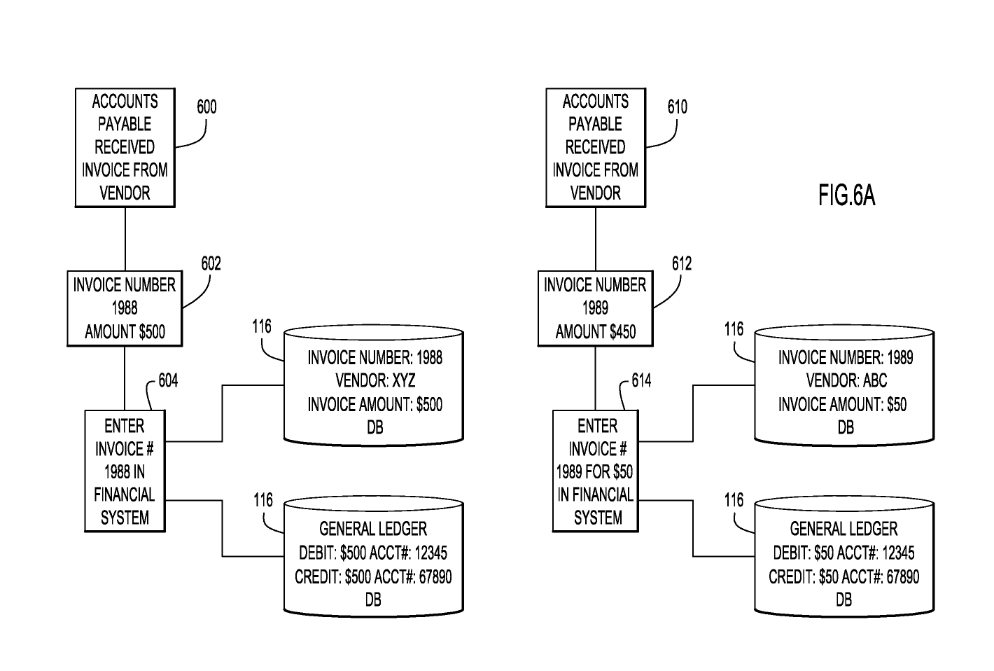

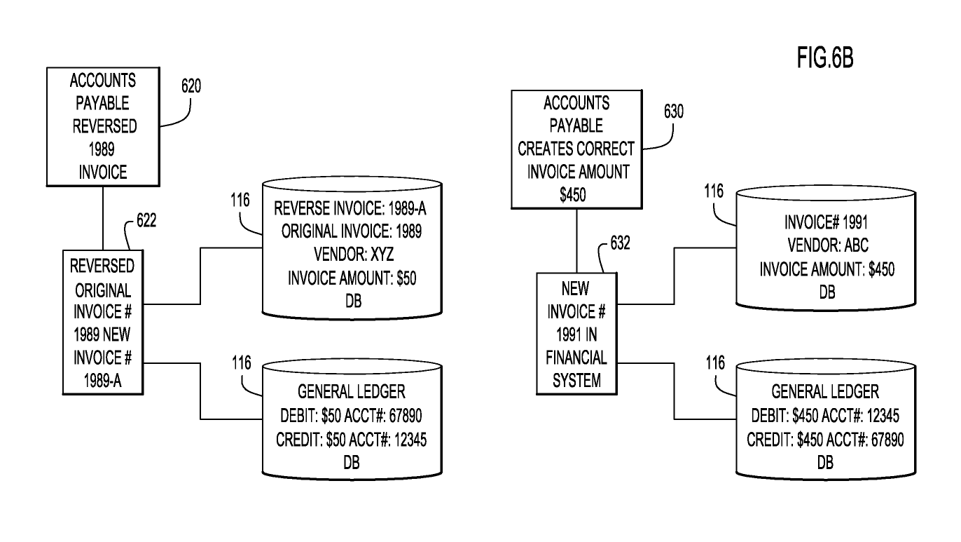

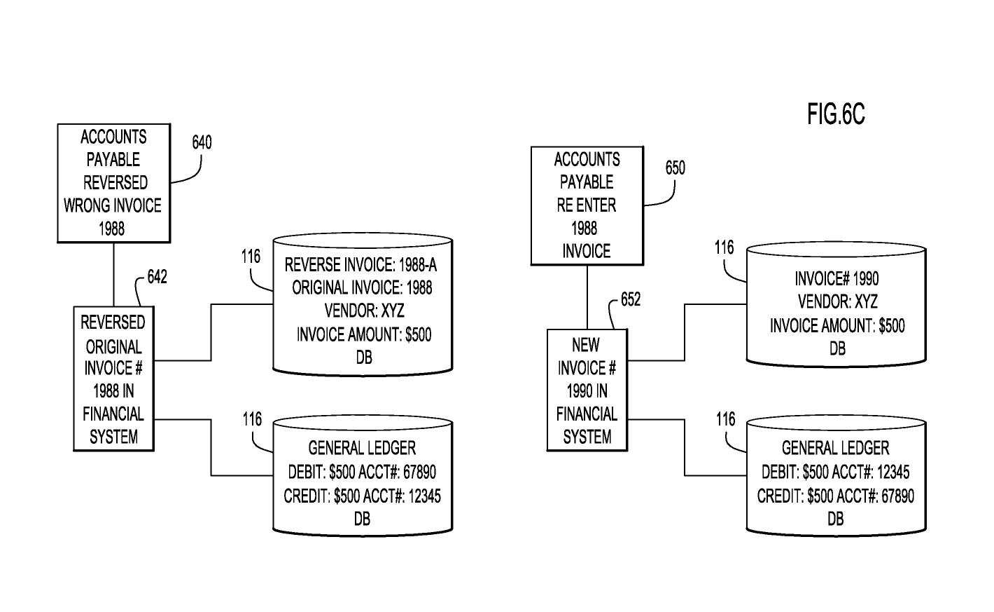

An example manner of financial system 110 processing invoices with a single stage is illustrated in FIGS. 6A-6C. By way of example, an invoice may be received from a vendor by an accounts payable or other unit of a business or other entity at step 600 (FIG. 6A). The received invoice may be in any desired form (e.g., electronic, hard copy form, etc.). The invoice may include an invoice number of 1988 and an amount of $500 (e.g., as viewed at flow 602). The received invoice is entered in financial system 110 at step 604 (e.g., via user interface screen 800), where the transaction is posted to database system 116 (e.g., invoice number, vendor, and amount as viewed in FIG. 6A) and the appropriate accounts of the General Ledger (e.g., $500 is debited to account number 12345 and credited to account number 67890 in the General Ledger as viewed in FIG. 6A).

Another invoice may be received from a vendor by the accounts payable unit of the business entity at step 610 (FIG. 6A). The invoice may be in any desired form (e.g., electronic, hard copy form, etc.). The invoice may include an invoice number of 1989 and an amount of $450 (e.g., as viewed at flow 612). However, this received invoice is entered in financial system 110 with an erroneous amount at step 614 (e.g., via user interface screen 800), where the transaction is posted to database system 116 (e.g., invoice number, vendor, and an incorrect amount of $50 as viewed in FIG. 6A) and the appropriate accounts of the General Ledger. In this case, $50 is debited to account number 12345 and credited to account number 67890 in the General Ledger instead of the correct amount of $450 as viewed in FIG. 6A.

In order to compensate for the erroneous entry of invoice number 1989, this invoice is reversed at step 620 (FIG. 6B) by financial system 110 (e.g., via reverse invoice module 300) generating a reverse invoice at step 622 with a new invoice number 1989-A and in the amount of $50 (e.g., via user interface screen 800 in substantially the same manner described above). The reverse invoice is automatically processed upon entry with an approved status as described above, and posted to database system 116 (e.g., reverse invoice number, original invoice number, vendor, and amount as viewed in FIG. 6B) and the appropriate accounts of the General Ledger (e.g., $50 is debited to account number 67890 and credited to account number 12345 in the General Ledger as viewed in FIG. 6B), thereby effectively nullifying the erroneous entry.

However, the original invoice amount of $450 still needs to be posted at step 630. Accordingly, financial system 110 (e.g., via new invoice module 210) enables a user to generate a new invoice at step 632 (FIG. 6B) with a new invoice number 1991 and in the amount of $450 to reflect the proper amount of the prior invoice (e.g., via user interface screen 800). The transaction is posted to database system 116 (e.g., invoice number, vendor, and amount as viewed in FIG. 6B) and the appropriate accounts of the General Ledger (e.g., $450 is debited to account number 12345 and credited to account number 67890 in the General Ledger as viewed in FIG. 6B).

If a wrong invoice is reversed, the reversed invoice needs to be restored. By way of example, the accounts payable unit may have reversed invoice number 1988 instead of invoice number 1989 at step 640 (FIG. 6C). The reverse invoice for invoice number 1988 is processed at step 642 upon entry with an approved status as described above, and posted to database system 116 (e.g., reverse invoice number, original invoice number, and amount as viewed in FIG. 6C) and the appropriate accounts of the General Ledger (e.g., $500 of invoice number 1988 is debited to account number 67890 and credited to account number 12345 in the General Ledger as viewed in FIG. 6C). In order to compensate for the erroneous reversal of invoice number 1988 at step 650, financial system 110 (e.g., via new invoice module 210) enables a user to generate a new invoice at step 652 with a new invoice number 1990 in the amount of $500 as viewed in FIG. 6C (e.g., via user interface screen 800). The transaction is posted to database system 116 (e.g., invoice number, vendor, and amount as viewed in FIG. 6C) and the appropriate accounts of the General Ledger (e.g., $500 is debited to account number 12345 and credited to account number 67890 in the General Ledger as viewed in FIG. 6C), thereby effectively nullifying the erroneous reversal. Although the single stage process has efficiencies by providing automatic postings upon entry of transactions with an approved status, several additional transactions are required in the case of an error.

Referring back to FIG. 5, the plural stage processing of a reverse invoice according to an embodiment of the present invention enables a user to selectively approve or cancel reversal of an invoice prior to the reversal being posted in the General Ledger, thereby avoiding posting of erroneous reversals and the need for several additional transactions to correct those postings. In particular, the plural stage processing commences at step 508, where a reverse invoice may be generated or selected by a user in an initial stage of the processing in substantially the same manners described above. Specifically, the generation or selection of a reverse invoice may be accomplished by financial system 110 (e.g., via invoice module 200) employing the graphical user interface (GUI) illustrated in FIGS. 8A-8B. User interface screen 800 includes invoice area 806 providing various fields pertaining to an invoice as described above (e.g., primary fields 815 pertaining to the invoice number, site location, type, and status, and plurality of sections 817 pertaining to invoice information (e.g., Invoice Details, PO (or purchase order) Details, Dates, Remit to, and Costs)).

The user may enter information within one or more of primary fields 815 (e.g., invoice number, site location, type, and status) to enable financial system 110 to retrieve information from database system 116 pertaining to a desired original invoice. The retrieved information is placed in the corresponding fields of invoice area 806 for display. Reverse invoice action 808 is selected by the user from drop-down menu 810, and invoice dialog box 820 is displayed by financial system 110 (e.g., via reverse invoice module 300). The invoice dialog box may include actuators or buttons 822, and fields pertaining to the invoice number, reason for the reversal, General Ledger posting date, and the invoice status as described above. Information pertaining to the desired reverse invoice is entered within the dialog box fields, and number generation button 824 may be utilized to generate the invoice number. In this case, the status for the reverse invoice is selected to be pending for later approval, and proceed button 826 is actuated to enable financial system 110 (e.g., via reverse invoice module 300) to create the reverse invoice.

Once a reverse invoice is entered into financial system 110, the reverse invoice may be selected by entering information within one or more primary fields 815 (e.g., invoice number, site location, type, and status) to enable financial system 110 (e.g., via reverse invoice module 300) to retrieve information from database system 116 pertaining to a desired reverse invoice. The retrieved information is placed in the corresponding fields of invoice area 806 for display.

Once a reverse invoice is created or selected (e.g., via user interface screen 800 in substantially the same manner described above), financial system 110 (e.g., via change status module 400) enables the user to selectively approve or cancel the reverse invoice within an intermediate stage of the processing at step 510 prior to posting to the General Ledger in a final stage of the processing at step 506. Referring to FIGS. 9A-9B, a change status action 812 is selected by the user from drop-down menu 810 of user interface screen 800 (FIG. 9A), and a status dialog box 900 (FIG. 9B) is displayed. The status dialog box may include fields pertaining to the reverse invoice number, current invoice status, new invoice status, and status date, and a close purchase order checkbox. Status dialog box 900 further includes actuators or buttons 922. These buttons may include a proceed button 926 (e.g., “OK” as viewed in FIG. 9B) to proceed with performance of the task, and a cancel button 928 (e.g., “Cancel” as viewed in FIG. 9B) to cancel performance of the task. Information pertaining to the reverse invoice is displayed within the status dialog box fields, and financial system 110 (e.g., via change status module 400) enables a new status for the reverse invoice to be selected by the user from a drop-down menu. The new invoice status includes, by way of example, approved (e.g., “Approved” as viewed in FIG. 9B) and canceled (e.g., “Cancel” as viewed in FIG. 9B).

If the reverse invoice is not approved (e.g., the new invoice status is “Cancel” and proceed button 928 is actuated on user interface screen 800) as determined at step 512 (FIG. 5), the reverse invoice is canceled at step 514, and the reverse invoice is removed from financial system 110 (e.g., via change status module 400). When the reverse invoice is approved (e.g., the new invoice status is “Approved” and proceed button 928 is actuated on user interface screen 800), the reverse invoice is processed by financial system 110 (e.g., via change status module 400) to reverse the original invoice at step 504, and the reverse invoice is posted to the General Ledger at step 506.

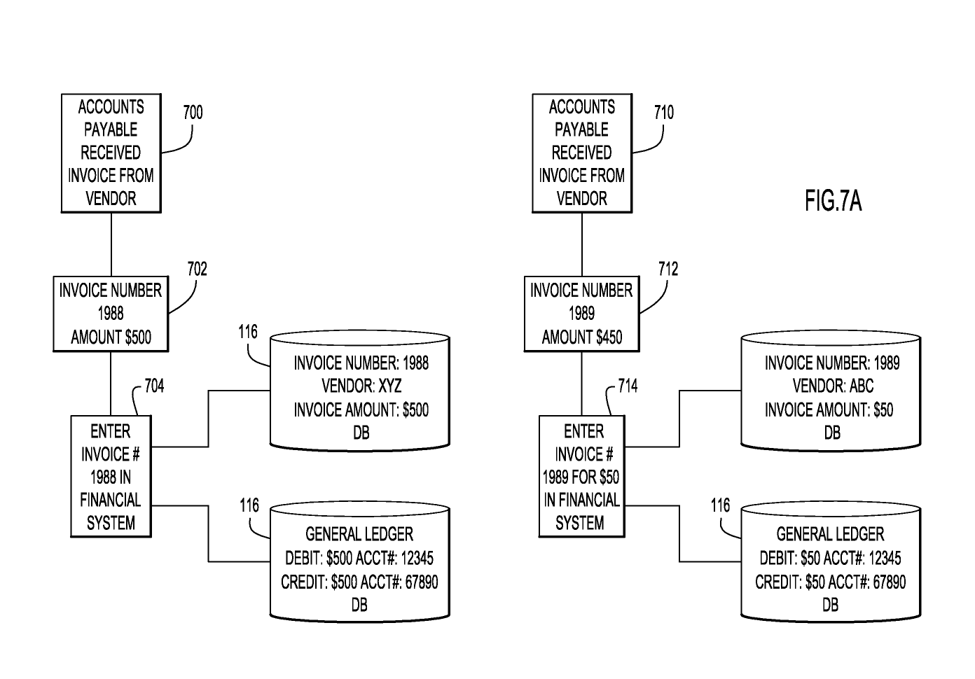

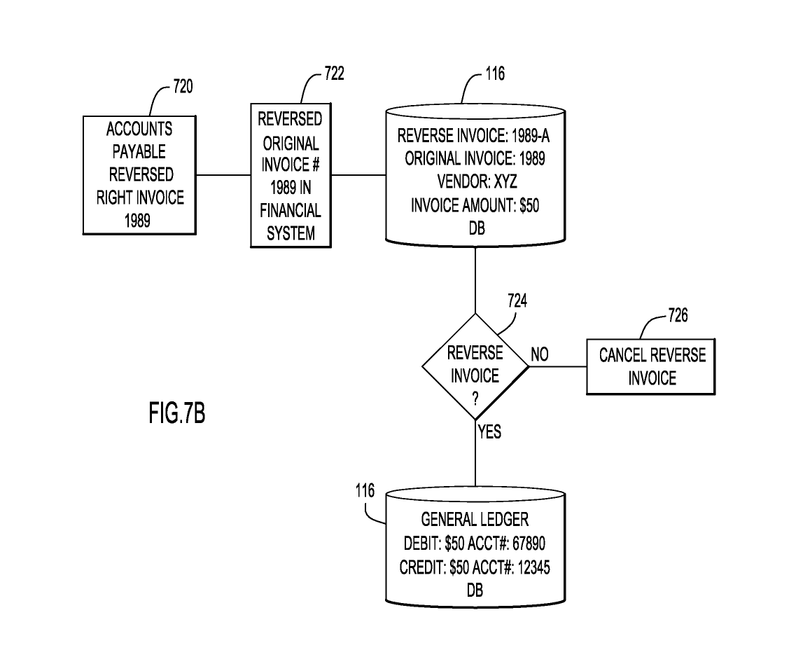

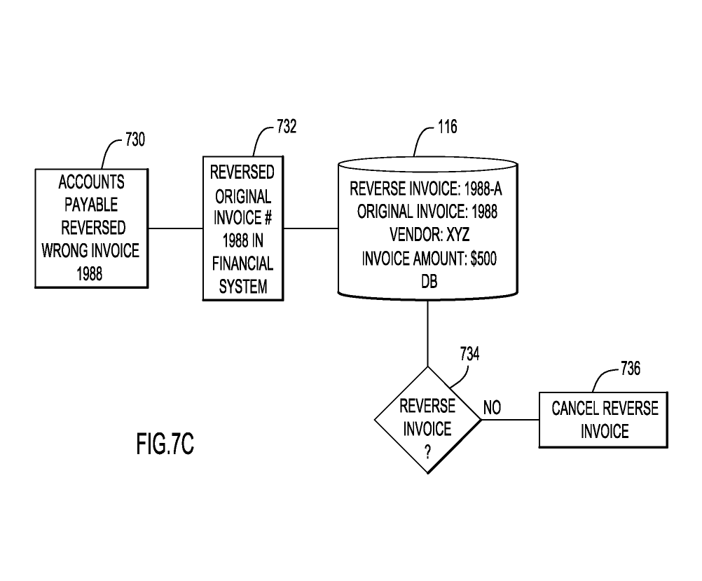

An example manner of financial system 110 processing invoices with plural stages is illustrated in FIGS. 7A-7C. By way of example, an invoice may be received from a vendor by an accounts payable or other unit of a business or other entity at step 700. The invoice may be in any desired form (e.g., electronic, hard copy form, etc.). The invoice may include an invoice number of 1988 and an amount of $500 (e.g., as viewed at flow 702). The received invoice is entered in financial system 110 at step 704 (e.g., via user interface screen 800), and the transaction is posted to database system 116 (e.g., invoice number, vendor, and an amount as viewed in FIG. 7A) and the appropriate accounts of the General Ledger (e.g., $500 is debited to account number 12345 and credited to account number 67890 in the General Ledger as viewed in FIG. 7A).

Another invoice may be received from a vendor by the accounts payable unit of the business entity at step 710 (FIG. 7A). The invoice may be in any desired form (e.g., electronic, hard copy form, etc.). By way of example, the invoice includes an invoice number of 1989 and an amount of $450 (e.g., as viewed at flow 712). However, this received invoice is entered in financial system 110 with an erroneous amount at step 714 (e.g., via user interface screen 800), and the transaction is posted to database system 116 (e.g., invoice number, vendor, and incorrect amount as viewed in FIG. 7A) and the appropriate accounts of the General Ledger. In this case, $50 is debited to account number 12345 and credited to account number 67890 in the General Ledger instead of the correct amount of $450 as viewed in FIG. 7A.

In order to compensate for the erroneous entry of invoice number 1989, the invoice is reversed at step 720 (FIG. 7B) by financial system 110 (e.g., via reverse invoice module 300) enabling a user to generate a reverse invoice at step 722 with a new invoice number 1989-A in the amount of $50 (e.g., via user interface screen 800 in substantially the same manner described above). The reverse invoice is posted to database system 116 (e.g., reverse invoice number, original invoice number, vendor, and an amount as viewed in FIG. 7B). Once a reverse invoice is created, financial system 110 (e.g., via change status module 400) enables the user to select and approve the reverse inverse prior to posting to the General Ledger (e.g., via user interface screen 800 in substantially the same manner described above). When the reverse invoice is approved (e.g., the status is changed to “Approved” via status dialog box 922) as determined at step 724, the reverse invoice is processed by financial system 110 (e.g., via change status module 400) and posted to the General Ledger to reverse the prior invoice (e.g., $50 is debited to account number 67890 and credited to account number 12345 in the General Ledger as viewed in FIG. 7B), thereby effectively nullifying the erroneous entry. However, financial system 110 (e.g., via new invoice module 210) enables the user to generate a new invoice to post the original invoice amount of $450 as described above. In the event the reverse invoice is not approved (e.g., the status is changed to “Cancel” via status dialog box 922) as determined at step 724, financial system 110 (e.g., via change status module 400) cancels the reverse invoice at step 726, and the reverse invoice is removed from the financial system without posting to the General Ledger.

If a wrong invoice is reversed, the reverse invoice corresponding to this reversal may be canceled without requiring additional transactions. For example, the accounts payable unit may have reversed invoice number 1988 instead of invoice number 1989 at step 730 (FIG. 7C). In this case, financial system 110 (e.g., via reverse invoice module 300) enables the user to generate the corresponding reverse invoice with invoice number 1988-A, and processes that reverse invoice (e.g., via check status module 400) at step 732. The reverse invoice is further posted to database system 116 (e.g., reverse invoice number, original invoice number, vendor, and amount as viewed in FIG. 7C). In order to cancel this reverse invoice, financial system 110 (e.g., via change status module 400) enables the reverse invoice to be canceled by the user (e.g., the status of the reverse invoice may be changed to “Cancel” via status dialog box 922) at step 734. The reverse invoice is removed from the financial system at step 736 without posting to the General ledger, thereby effectively nullifying the erroneous reversal without the need for additional transactions. The correct invoice (e.g., invoice number 1989) may subsequently be reversed in substantially the same manner described above.

It will be appreciated that the embodiments described above and illustrated in the drawings represent only a few of the many ways of implementing embodiments for selective processing of reverse invoices in computer systems for financial transactions.

The topology or environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems (e.g., financial systems, client systems, etc.) employed by the present invention embodiments may be implemented by any number of any personal or other type of computer or processing system (e.g., IBM-compatible, laptop, PDA, mobile devices, etc.), and may include any commercially available operating system and any commercially available or custom software (e.g., browser software, communications software, server software, invoice processing and accounting or financial software, etc.). These systems may include any types of monitors and input devices (e.g., keyboard, mouse, voice recognition, etc.) to enter and/or view information.

It is to be understood that the software (e.g., invoice module, new invoice module, reverse invoice module, change status module, chart of accounts module, exchange rates module, etc.) of the present invention embodiments may be implemented in any desired computer language and could be developed by one of ordinary skill in the computer arts based on the functional descriptions contained in the specification and flow charts and/or diagrams illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and financial/server systems, and/or any other intermediary processing devices. The software and/or algorithms described above and illustrated in the flow charts and/or diagrams may be modified in any manner that accomplishes the functions described herein. In addition, the functions in the flow charts and/or diagrams or description may be performed in any order that accomplishes a desired operation.

The software of the present invention embodiments (e.g., invoice module, new invoice module, reverse invoice module, change status module, chart of accounts module, exchange rates module, etc.) may be available on a recordable or computer usable medium (e.g., magnetic or optical mediums, magneto-optic mediums, floppy diskettes, CD-ROM, DVD, memory devices, etc.) for use on stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The present invention embodiments may employ any number of any conventional or other databases, data stores or storage structures (e.g., files, databases, data structures, data or other repositories, etc.) to store information (e.g., financial or other data, General Ledger or other financial records, etc.). The database system may be implemented by any number of any conventional or other databases, data stores or storage structures (e.g., files, databases, data structures, data or other repositories, etc.) to store any desired information (e.g., transactions, invoices, General Ledger, financial or other journals, etc.). The database system may be included within or coupled to the server and/or client systems. The database systems and/or storage structures may be remote from or local to the computer or other processing systems, and may store any desired data (e.g., transactions, invoices, General Ledger, financial or other journals, etc.).

Present invention embodiments may be utilized for selectively approving or canceling any type of financial or other data transactions (e.g., invoices, receipts, payments, credits, debits, data entries, etc.) prior to posting within any suitable data storage structure (e.g., General Ledger, financial or other journals, databases, files, data structures, etc.) or unit (e.g., database, data repository, etc.). The financial system may further authenticate a user prior to enabling generation, approval and/or cancellation of an invoice or other entry. The authentication may be implemented via any conventional or other techniques (e.g., password or passcode, PIN, biometrics, security or other readable card or device, voice recognition, etc.). Further, the authentication may require any quantity of users (e.g., any quantity of authorized users may be required for approval or cancellation of an invoice, etc.).

The various financial documents (e.g., records within the General Ledger or other journal, invoices, etc.) may include any desired information (e.g., account information, dates, amounts, transactions, identifiers, etc.) arranged in any fashion. The various reference numbers (e.g., invoice, reverse invoice, account, purchase order, bank, etc.) may include any quantity of any suitable characters (e.g., numeric, alphanumeric, symbols, etc.). The invoices or other financial documents (e.g., new invoice, original invoice, reverse invoice, etc.) are preferably entered and processed in the financial system in electronic form. However, these items may alternatively be entered, generated and/or produced in any desired form or fashion (e.g., electronically, hard copy form, etc.).

The invoices (e.g., original, reverse, etc.) may be stored and retrieved in any desired fashion (e.g., based on any suitable information or fields contained within the invoices, etc.). A pending reverse invoice may be maintained in the database system for any desired time interval (e.g., days, weeks, months, etc.) to enable approval prior to an automatic cancellation.

The present invention embodiments may employ any number of any type of user interface (e.g., Graphical User Interface (GUI), command-line, prompt, etc.) for obtaining or providing information (e.g., obtaining information for the desired financial or other transaction, original and reverse invoices, providing the report, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The report may include any information arranged in any fashion (e.g., pertaining to financial or other information, invoices, General Ledger, etc.). The report may be configurable based on rules or other criteria to provide desired information to a user (e.g., certain accounts or transactions, certain accounts or postings within the General Ledger or other journal, etc.).

The present invention embodiments are not limited to the specific computer systems, tasks, or algorithms described above, but may be utilized within any system for selectively processing various types of financial transactions or other entries prior to posting within a corresponding data structure or storage unit. The present invention embodiments may be configured to provide single stage (e.g., automatic posting of data upon entry with or without an approved status) and/or plural stage (e.g., selective posting of data after entry) operation.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (Java and all Java-based trademarks and logos are trademarks of Sun Microsystems, Inc. in the United States, other countries, or both), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method of managing financial records within a computerized financial system comprising:
generating an electronic invoice representing a financial transaction within the computerized financial system to rectify financial records of the computerized financial system adjusted in accordance with a prior processed invoice;
selectively storing for subsequent verification the generated electronic invoice without adjustment of the financial records; and
processing the stored electronic invoice in the computerized financial system and rectifying the financial records in accordance with the represented financial transaction in response to verification of the stored electronic invoice.

2. The computer-implemented method of claim 1, wherein the generating an electronic invoice includes generating the electronic invoice with an approved status, and automatically processing the generated electronic invoice in accordance with the represented financial transaction.

3. The computer-implemented method of claim 1, wherein the stored electronic invoice includes a pending status, and the method further includes:
selectively altering the status of the stored electronic invoice from a pending status to one of an approved status and a canceled status, wherein the verification of the stored electronic invoice is based on the status of that invoice.

4. The computer-implemented method of claim 3, wherein the processing the stored electronic invoice further includes:
processing the stored electronic invoice in the computerized financial system and rectifying the financial records in accordance with the represented financial transaction in response to an approved status of the stored electronic invoice.

5. The computer-implemented method of claim 3, further including:
removing the stored electronic invoice from the computerized financial system without rectifying the financial records in response to a canceled status of the stored electronic invoice.

6. The computer-implemented method of claim 3, wherein the computerized financial system includes a user interface, and the selectively altering the status includes:
selectively altering the status of the stored electronic invoice from a pending status to one of an approved status and a canceled status via the user interface.

7. A system for managing financial records comprising:
a computer system including at least one processor configured to:
generate an electronic invoice representing a financial transaction to rectify financial records adjusted in accordance with a prior processed invoice;
selectively store for subsequent verification the generated electronic invoice without adjustment of the financial records; and
process the stored electronic invoice and rectify the financial records in accordance with the represented financial transaction in response to verification of the stored electronic invoice.

8. The system of claim 7, wherein the generating an electronic invoice includes generating the electronic invoice with an approved status, and automatically processing the generated electronic invoice in accordance with the represented financial transaction.

9. The system of claim 7, wherein the stored electronic invoice includes a pending status, and the at least one processor is further configured to:
selectively alter the status of the stored electronic invoice from a pending status to one of an approved status and a canceled status, wherein the verification of the stored electronic invoice is based on the status of that invoice.

10. The system of claim 9, wherein the processing the stored electronic invoice further includes:
processing the stored electronic invoice and rectifying the financial records in accordance with the represented financial transaction in response to an approved status of the stored electronic invoice.

11. The system of claim 9, wherein the at least one processor is further configured to:
remove the stored electronic invoice without rectifying the financial records in response to a canceled status of the stored electronic invoice.

12. The system of claim 9, wherein the computer system includes a user interface, and the selectively altering the status includes:
selectively altering the status of the stored electronic invoice from a pending status to one of an approved status and a canceled status via the user interface.

13. A computer program product for managing financial records within a computerized financial system comprising:
a computer readable storage medium having computer readable program code embodied therewith, the computer readable program code comprising computer readable program code configured to:
generate an electronic invoice representing a financial transaction within the computerized financial system to rectify financial records of the computerized financial system adjusted in accordance with a prior processed invoice;
selectively store for subsequent verification the generated electronic invoice without adjustment of the financial records; and
process the stored electronic invoice and rectify the financial records in accordance with the represented financial transaction in response to verification of the stored electronic invoice.

14. The computer program product of claim 13, wherein the generating an electronic invoice includes generating the electronic invoice with an approved status, and automatically processing the generated electronic invoice in accordance with the represented financial transaction.

15. The computer program product of claim 13, wherein the stored electronic invoice includes a pending status, and the computer readable program code further comprises computer readable program code configured to:
selectively alter the status of the stored electronic invoice from a pending status to one of an approved status and a canceled status, wherein the verification of the stored electronic invoice is based on the status of that invoice.

16. The computer program product of claim 15, wherein the processing the stored electronic invoice further includes:
processing the stored electronic invoice and rectifying the financial records in accordance with the represented financial transaction in response to an approved status of the stored electronic invoice.

17. The computer program product of claim 15, wherein the computer readable program code further comprises computer readable program code configured to:
remove the stored electronic invoice from the computerized financial system without rectifying the financial records in response to a canceled status of the stored electronic invoice.

18. The computer program product of claim 15, wherein the computerized financial system includes a user interface, and the selectively altering the status includes:
selectively altering the status of the stored electronic invoice from a pending status to one of an approved status and a canceled status via the user interface.
